(19) United States
(12) Patent Application Publication
(10) Pub. No.: US 2005/0030743 A1
(43) Pub. Date: Feb. 10, 2005

(54) Socket device

(75) Inventors: Masamitsu Nagano, Imabari-shi (JP); Kazuo Yomita, Imabari-shi (JP); Toshiyuki Arai, Yokohama-shi (JP)

Correspondence Address: BANNER & WITCOFF, 1001 G STREET N W, SUITE 1100, WASHINGTON, DC, 20001, US

(73) Assignee: Harison Toshiba Lighting Corporation, Imabari-shi (JP)

(21) Appl. No.: 10/887,315

(22) Filed: Jul. 9, 2004

(30) Foreign Application Priority Data
Jul. 14, 2003 (JP) 2003-196418

(51) Int. Cl. H01R 33/00

(52) U.S. Cl. 362/226

(57) ABSTRACT

A socket device according to an embodiment of the present invention includes a tubular main body 1 made of an electrically insulating material. The tubular main body 1 provides a lamp-loading hole 12 having an opening at upper end, through which a baseless lamp 6 is inserted. A notch 3 is formed in a wall of the tubular main body 1, which extends downward from the opening of the lamp-loading hole 12 along an axis of the tubular main body 1. A flange portion 2 is provided around the tubular main body 1 at a portion spaced from the lower end of the notch 3. First and second protrusions 41, 42 are provided on both sides of the notch portion 3 on the outer surface of the tubular main body 1. An electrically conducting connecting member 5a having a terminal piece 53 is provided so that the base portion 51 of the terminal piece 53 is inserted in the lamp-loading hole and a leading portion of the terminal piece 53 passes through the notch portion 3 extending to a position between the first and the second protrusions 41, 42.

### BACKGROUND TECHNOLOGY OF THE INVENTION

The present invention relates to a socket device for loading baseless lamps such as small size incandescent lamps or light emitting diodes.

Socket devices for baseless lamps such as incandescent lamps and light emitting diodes are widely used in audio and video instruments, meters for cars, liquid crystal displays, or displays for a controller used in plants. Those socket devices have such merits that supporting and electrical connections of the lamps can be easily made with a simple structure and a low cost when they are assembled on printed circuit boards.

The conventional socket device for baseless lamps is provided with a tubular main body, which is a bottomed cylinder made of electrically insulating material such as resin or rubber. The tubular main body has a lamp-loading hole having an opening at upper end, through which a baseless lamp is inserted. In the outer wall forming the lamp-loading hole, a pair of notches is formed, which extend downward along the tubular socket axis from the leading end of the hole. The pair of notches is arranged on the diametrically opposing positions of the lamp-loading hole. On the outer surface of the tubular main body, flange portion is also provided around the tubular main body at a prescribed distance from the lower ends of the pair of notches. A protrusion is also provided at a prescribed distance from the flange portion on the outer surface of the tubular main body. The protrusion is arranged at a position spaced from the notches in the circumferential direction of the outer surface of the tubular main body. Electrically conducting connecting members made of a metal plate are provided in the loading hole. Sealing portions of a wedge base type lamp is connected and is supported on the connecting members. A pair of terminal pieces is connected with the connecting member. These terminal pieces pass through the pair of notches and extrude on the outer side of the tubular main body.

The socket device is assembled after inserting the tubular main body having the protrusion into a socket assembly hole formed on a printed circuit board, by turning the main body with the printed circuit board sandwiched between the protrusion and the flange portion. At this time, the terminal piece is in contact with a wire conductor made of such a thin film as a copper foil formed on the surface of the printed circuit board, through which electricity is supplied to turn on the lamp.

Here, in one type of the socket device known to the public, the terminal piece is arranged to protrude at a position spaced from the flange portion, and to contact with wire conductors formed on an upper surface of the printed circuit board.

In the other type of the socket device also known to the public, the terminal piece is received in a concave portion formed in the flange portion, in order to contact with the wire conductors formed on an under surface of the printed circuit board.

In yet other type of the socket device known to the public, the above-mentioned two types are combined, in which a pair of terminal pieces is provided, which is contact with the both sides of the board, when the socket device is loaded on the printed circuit board.

In the conventional socket devices described, the terminal pieces are protruding from the outer surface of the main body of the socket device. Therefore, when a lot of the socket devices are put together into a container boxes while manufacturing, assembling or carrying, the terminal pieces protruding from the socket body contact with other socket devices or a wall of the container box, and sometimes they are deformed. If such deformation takes place in the terminal piece, insufficient contact between the terminal piece and the wire conductor of the printed circuit board occurs, and, in the worst case, it is impossible to assemble the socket device on the printed circuit board.

It is an object of the present invention to solve the above-mentioned problems, and to provide a socket device, in which the deformation of the terminal pieces extruding from the outer surface of the main body of the socket device is prevented and an electric connection is secured.

### SUMMARY OF THE INVENTION

The socket device according to an embodiment of the present invention includes a tubular main body made of an electrically insulating material. The tubular main body provides a lamp-loading hole having an opening at an upper end, through which a baseless lamp is inserted. A notch portion is formed in a wall of the tubular main body, which extends from the opening of the lamp-loading hole along an axis of the tubular main body. A flange portion is provided around the tubular main body at a portion spaced from the lower end of the notch. First and second protrusions are provided on both sides of the notch portion on the outer surface of the tubular main body. An electrically conducting connecting member having a terminal piece is provided so that the base portion of the terminal piece is inserted in the lamp-loading hole and a leading portion of the terminal piece passes through the notch portion extending to a position between the first and the second protrusions.

In the socket device according to the embodiment of the present invention, the leading portion of the terminal piece is provided at a position spaced from the flange portion.

In the socket device according to the embodiment of the present invention, the terminal piece is made in contact with the wire conductor formed on the surface of the printed circuit board, when the socket device is loaded on a printed circuit board.

Further, in the socket device according to the embodiment of the present invention, the socket device is inserted in the loading hole formed on the printed circuit board and is assembled by turning the main body in the loading hole with the printed circuit board sandwiched between the flange portion and the first and the second notches. In this way the socket device is loaded on the printed circuit board.

Further, in the socket device according to the embodiment of the present invention, the first protrusion is provided, having a stopper portion which is extended to the flange portion or to its vicinity, so as to stop further turning of the socket device on the printed circuit board, when the socket device is loaded on the loading hole of the printed circuit board.

Further, in the socket device according to the embodiment of the present invention, the second protrusion has an under surface facing with the flange portion, which is inclined so as to make it easy for the printed circuit board to be inserted into the gap between the under surface of the second protrusion and the flange portion, when the socket device is loaded in the loading hole of the printed circuit board.

Further, in the socket device according to the embodiment of the present invention, the baseless lamp is supported by and connected with the base portion of the connecting member loaded in the lamp-loading hole of the tubular main body.

The socket device according to the embodiment of the present invention, the deformation of the terminal pieces can be prevented when it is put together with other socket devices into the container box while it is manufactured, assembled or carried, because the leading portion of the electrically conducting terminal pieces protruding from the tubular main body are provided at a position protected by the first and second protrusions as well as by a flange portion from being in contact with other socket devices or the inner wall of the container box.

### BRIEF DESCRIPTION OF THE DRAWINGS

FIG. 1 is a front view showing a first embodiment of the socket device according to the present invention;

FIG. 2 is a top view showing the socket device shown in FIG. 1;

FIG. 3 is a bottom view showing the socket device shown in FIG. 1;

FIG. 4 is a perspective view showing a connecting member of the socket device shown in FIG. 1;

FIG. 5 is a front view of a baseless incandescent lamp to be loaded on the socket device shown in FIG. 1;

FIG. 6 is a side sectional view partly showing an example of display unit in which the socket device shown in FIG. 1 is used;

FIG. 7 shows the socket device shown in FIG. 1 loaded on a printed circuit board, wherein (a) is a plan view showing a part of the circuit board, (b) is a plan view showing a part of the printed circuit board in which the socket device is loaded;

FIG. 8 is a front view showing a second embodiment of the socket device according to the present invention; and

FIG. 9 shows a connecting member used for the socket device shown in FIG. 8, wherein (a) is a front view, (b) is a side view.

### DETAILED DESCRIPTION OF THE INVENTION

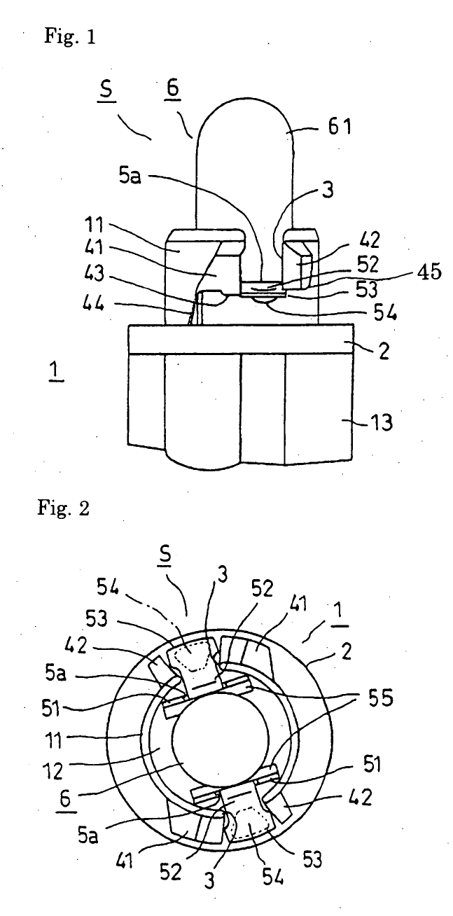

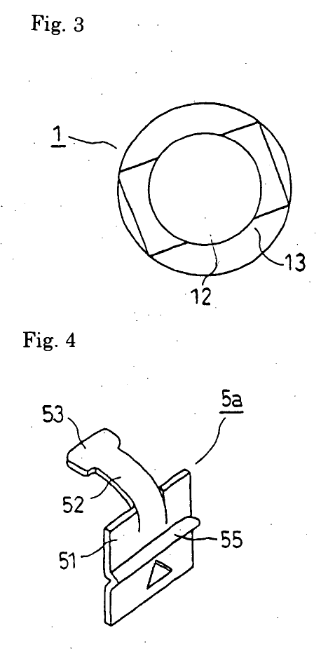

An embodiment of the socket device according to the present invention will be explained below referring to FIG. 1 to FIG. 4. FIG. 1 is a front view of the socket device S. FIG. 2 is an upper view of the socket device S. FIG. 3 is a bottom view of the socket device S. FIG. 4 is a perspective view of a connecting member used in the socket device S.

In the figures, a tubular main body 1 includes a bottomed cylinder having a cylindrical cross section made of an electrically insulating material. As the electrical insulating material, thermoplastic resin such as, for example, 66 Nylon (a trade name) is used. The tubular main body 1 provides a lamp-loading hole 12 having an opening at its upper end, from which a baseless small lamp is inserted, as described below. On the outer surface of a wall 11 of the tubular main body 1, a pair of notches 3, 3 are formed extending downward from the opening of the lamp-loading hole 12 along an axis of the tubular main body 1. The notches 3, 3 are provided on the diametrically opposite positions of the lamp-loading hole 12. A flange portion 2 is provided around the tubular main body 1 at a portion spaced from the lower end of the notches 3, 3. First and second protrusions 41 and 42 are provided on both sides of each of the notches 3, 3 on the outer surface of the tubular main body 1. The first protrusion 41 has a stopper portion 44, which is extended to an upper surface of the flange portion 2 or to its vicinity. A convex portion 43 is formed on the lower surface of the first protrusion 41. A space between an under surface of the concave portion 43 and the upper surface of the flange portion 2 is selected to be equal to or a little bit smaller than a thickness of a printed circuit board, as will be described later. On the other hand, the second protrusion 42 has an under surface 45 facing with the flange portion 2 and being inclined with respect to the upper surface of the flange portion 2.

A base portion 51 forming a connecting member 5a is loaded in the lamp-loading hole 12, as shown in FIG. 4. A coupling convex 55 is formed on a substantially planer base portion 51, which fits in a concave portion (not illustrated) formed on an inner wall of the lamp-loading hole 12 and is fixed there. The connecting member 5a, made of electrically conducting material, has a terminal piece 53 connected with the base portion 51. The terminal piece 53 passes through the notches 3, 3. A leading portion of the terminal piece 53 is extended to a portion between the first and second protrusions 41 and 42. The terminal piece 53 is bent outward at its central portion 52 to provide a downward elastic force to the leading end. A convex contacting portion 54 is formed on the lower surface of the leading end of the terminal piece 53. The leading end of the terminal piece 53 is located at a position facing the upper surface of the flange 2 with a prescribed spacing.

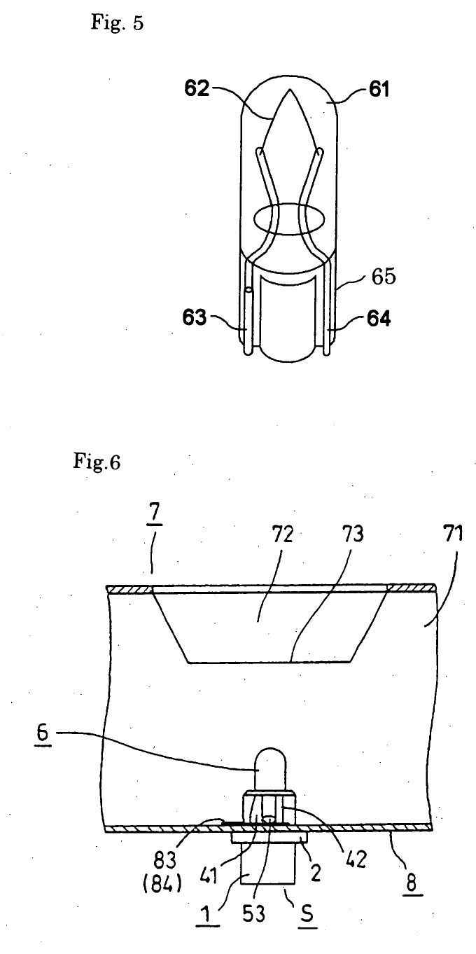

Next, a baseless small lamp 6 of wedge base type has a glass bulb 61 forming an envelope as shown in FIG. 5. A coiled filament 62 is enclosed in the glass bulb 61. Outer leads 63, 64 connected with the filament 62 are led to a lower sealed portion 65 of the glass bulb 61. End portions of the outer leads 63, 64 are led out of the lower sealed portion 65. The end portions of the outer leads 63, 64 are folded back along a front surface and a rear surface of the sealing portion 65 respectively. When the baseless small lamp 6 is inserted into the lamp-loading hole 12, the end portions being folded back of the outer leads 63, 64 contact with a flat base portion 51 of a pair of connecting members 5a, 5a, which are provided inside the lamp-loading hole 12.

The socket device according to the embodiment of the present invention, the deformation of the electrically conducting terminal pieces 53 can be prevented when it is put together with other socket devices into the container box while it is manufactured, assembled or carried, because the leading portion of the electrically conducting terminal pieces 53 protruding from the tubular main body 1 are provided at a position protected by the first and second protrusions 41, 42 as well as by a flange portion 2 from being in contact with other socket devices or the inner wall of the container box.

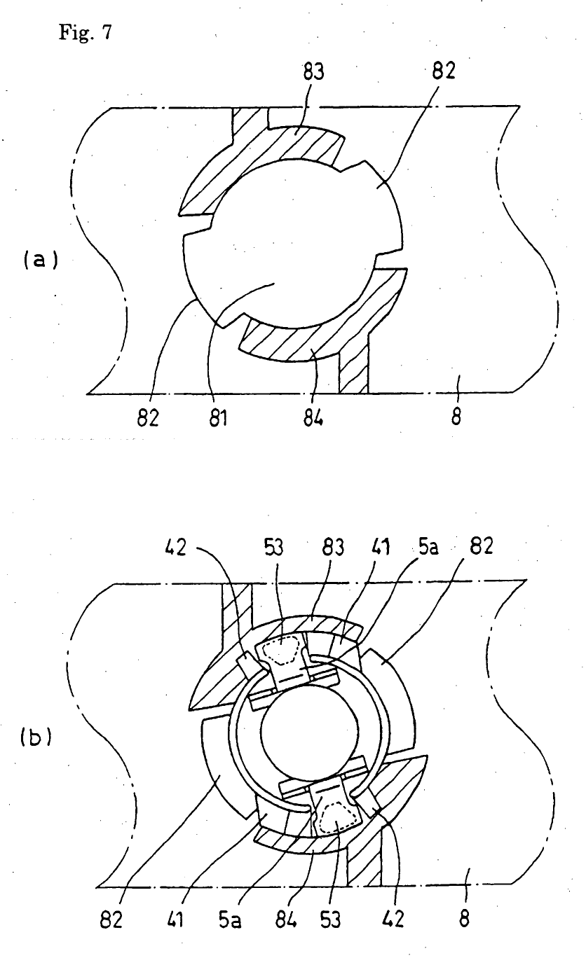

FIG. 6 is a side sectional view showing a part of a display unit 7 assembled in a meter for cars, in which the socket device S is mounted. FIG. 7 is a figure for explaining a method for mounting the socket device on a printed circuit board, wherein FIG. 7 (a) is a plan view showing a part of printed circuit board on which a socket device is mounted, FIG. 7 (b) is a plan view showing a part of printed circuit board on which socket device is mounted.

The display unit 7 is provided with a display plate 73 for displaying a warning message such as “DOOR OPEN”, for example, on the concave portion 72 in front of a chassis 71. A socket device S is loaded in the socket loading hole 81 of the printed circuit board 8 arranged at a position facing the display plate 73, as shown in FIG. 7 (a) . On the printed circuit board 8 on which the socket device S is mounted, a socket loading hole 81 having nearly similar shape as the cross section of tubular main body 1 is provided. The loading hole 81 is nearly circular shape as a whole, and is provided with two recess portions 82, 82 at the opposite positions on the diameter of the loading hole 81. The recess portions 82, 82 are formed for passing the protrusions 41, 42 provided on tubular main body 1 when it is inserted into the loading hole 81. The length of the recess portions 82, 82 along the circumference of the loading hole 81 is so selected as the protrusion 41, 42 are allowed to pass through and to turn in the circumferential direction. On the surface of the printed circuit board 8, where the loading hole 81 is formed, wire conductors 83, 84 are printed in the vicinity of the loading hole 81. The wire conductors 83, 84 are formed on one side or on both sides of the printed circuit board 8.

Mounting of the socket device S on the printed circuit board 8 is carried out as follows. After adjusting the recess portions 82, 82 of the loading hole 81 of the printed circuit board 8 with the protrusion 41, 42, the socket device S is inserted into the loading hole 81 from a top portion of the bulb 61 of the small lamp 6 mounted in the socket device S. The socket device S is advanced until the flange portion 2 of the tubular main body 1 contacts with the printed circuit board 8. When the flange portion 2 is in contact with the printed circuit board 8, a grip portion 13 formed on the lower side of the tubular main body 1 is grasped and turned clockwise by hand. As a result, the printed circuit board 8 is sandwiched between the flange portion 2 and the protrusion 41, 42 and is fixed tight there. At this time, the terminal piece 53 contacts elastically with the surface of the flange portion 2. Then, the contacting portion 54 at the leading end of the terminal piece 53 is pressed to the wire conductor 83, 84 to make an electrical connection.

When turning the tubular main body 1 inserted in the loading hole 81, the convex portion 43 on the under surface of the first protrusions 41 and the inclined under surface 45 of the protrusion 42 slide smoothly on the surface of the wire conductors around the loading hole 81 of the printed circuit board 8. Here, the under surface 45 of the second protrusion 42 is made inclined with respect to the upper surface of the flange portion 2, a space between the under surface 45 and the upper surface of the flange portion 2 on one side, from which the printed circuit board 8 is inserted becomes larger than that on the other side. When the tubular main body 1 is turned by a prescribed angle, the stopper 44 provided on the first protrusion 41 contacts with the periphery of the recess portion 82, 82 formed on the printed circuit board 8, and stops further turn of the tubular main body 1, thereby completing the positioning the socket device S.

Next, dismounting of the socket device S from the printed circuit board 8 for replacement of baseless small lamp 6 or some other reasons is carried out by grasping the grip portion 13, turning it counterclockwise until the protrusions 41, 42 reach the recess portion 82, 82, and by withdrawing the socket device S from the socket loading hole 81.

With the socket device S as described, there is no fear of deformation of the terminal piece 53 when the socket device S is mounted in the loading hole 81 of the printed circuit board 8, because the terminal piece 53 led out from the tubular main body 1 is placed at a position enclosed by protrusion 41, 42 or by flange portion 2. Therefore, the mounting can be done easily and smoothly as well as a reliable electric connection can be secured.

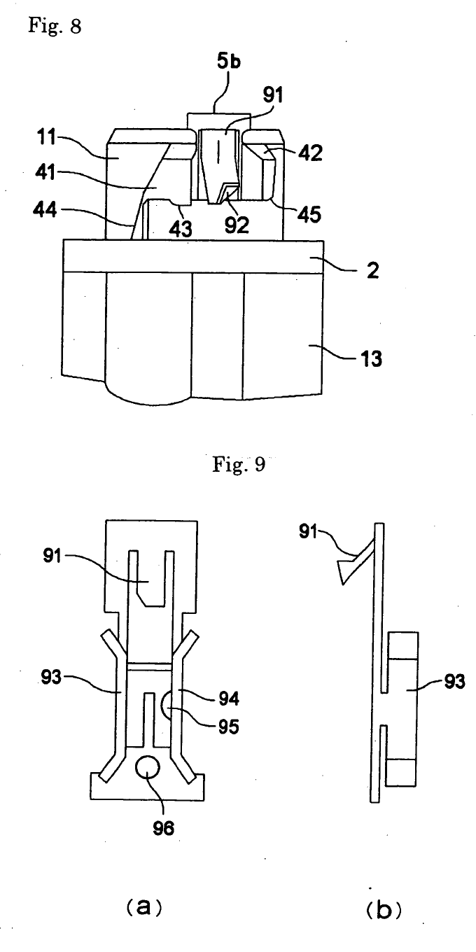

FIG. 8 is a side view showing another embodiment of the socket device according to the present invention. In the present embodiment, the connecting member 5a in the embodiment described above is replaced by connecting members 5b, 5b having a different shape. FIG. 9 shows a rough sketch of the connecting member 5b, wherein (a) is a front view, (b) is a side view. The connection member 5b is provided with an electrically conducting terminal piece 91, which is connected with a base portion 90 made of metal plate. A corner portion of a leading end of the terminal piece is bent upward. On the base portion 90, a pair of pinching pieces 93, 94 which are arranged parallel and facing each other. On at least one of the pinching pieces 93, 94, a contacting protrusion 95 is formed. On the base portion 90, a coupling convex 96 is formed.

The connecting members 5b, 5b thus formed is inserted and fixed in the mounting groove (not illustrated) formed on the inner wall of the loading hole 12 of the tubular main body 1. At this time, the coupling convex 96 is received in a concave portion (not illustrated) formed on the inner wall of the loading hole 12 of the tubular main body 1. When the socket device S is inserted in the lamp-loading hole 12, both side portions of the lower sealing portion 65 of the baseless small lamp shown in FIG. 5 is inserted between the pinching pieces 93, 94 of the connecting members 5b, 5b and are supported by the pinching pieces 93, 94 with their elastic force. When the baseless small lamp 6 is inserted in the lamp-loading hole 12, end portions of the outer leads 63, 64 folded back on both side of the sealing portion 65, contact with the nearly planer base portion 51 of the connecting member 5a, which is loaded in the lamp-loading hole 12, and are electrically connected.

Next, method for loading or unloading the socket device S, into which a baseless small lamp 6 is inserted, in or from the lamp-loading hole 12 of the printed circuit board 8 is performed similarly as stated above in the first embodiment, thereby omitting a detailed explanation. Here, in the present embodiment, not only the under surface 45 of the second protrusion 42 is inclined but also the corner of the leading end of the terminal piece 91 on the side of the second protrusion 42 is bent upward. Consequently, when turning the tubular main body 1 inserted in the loading hole 81 in order to load the socket device S on the printed circuit board 8, there is no fear of the deformation of terminal piece 91 by collision with the edge of the recess portion 82, 82 of the printed circuit board 8, it slides smoothly on the wire conductors around the loading hole 81 of the printed circuit board 8.

Also in the socket device S of the second embodiment of the present invention, when loading socket device in the loading hole 81 of the printed circuit board 8, there is no fear of deformation of the terminal piece 91, because the terminal piece 91 led out of the tubular main body 1 is extending to a position enclosed by protrusion 41, 42 or flange portion 2. Therefore, the loading operation can be performed easily and smoothly as well as a reliable electrical connection is secured.

The present invention is not limited to the above-mentioned embodiments, but various modifications are available as will be mentioned below.

Firstly, the baseless lamp to be loaded on the tubular main body 1 is not limited to the electric lamp, but LED (light emitting diode) lamp or small size electric discharge lamp may be used.

Secondly, rubber can be used for a material making the tubular main body 1 other than the thermoplastic resin such as 66 Nylon (brand name). The cross section of the tubular main body 1 is not limited to be cylindrical, but may be quadrangular or polygonal.

Thirdly, the flange portion 2 formed on the outer surface of the tubular main body 1 may partly include a deficit portion in its outer periphery.

Fourthly, the first and the second protrusion 41, 42 formed on the outer surface of the tubular main body 1, were provided 2 sets (1 pair) on the opposite position (180°) in the diametrical direction. However, only one protrusion 41 or 42 maybe provided on the outer surface of the tubular main body 1 or three or more protrusions may be provided at a prescribed angle spacing on the cross sectional plane of the tubular main body 1. In this case, loading the socket device S for a polarity specified lamp such as LED lamp etc. with a wrong polarity can be prevented by varying the angle spacing instead of employing an equal spacing.

Fifthly, the first and the second protrusion 41, 42 may change their position to each other. In that case, the turning direction of the socket device S when loading on the printed circuit board 8 is reversed with respect to the first embodiment.

Sixthly, the connecting members 5a or 5b can be made of a metal plate having electric conductivity and elasticity such as brass or stainless steel. The shapes of the bent portion of the metal plate are not limited to those in the above-mentioned embodiment. Further, the terminal piece 53 or 91 led out of the notch 3 is provided on a side of the printed circuit board 2, where the first and the second protrusions 41, 42 are provided. However, another terminal piece may be provided at a position facing to the terminal piece 53 or 91 on the other side of the printed circuit board 2. In this case, it is preferable to put the terminal piece in a groove formed on the surface of the flange 2.

1. A socket device comprising:
a tubular main body which is composed of electrically insulating material forming a lamp-loading hole having an opening at an upper end from which a baseless lamp is inserted,
a notch formed in a wall of the tubular main body extending downward from the opening of the lamp-loading hole along its axis,
a flange portion formed at an lower end portion of the notch on an outer surface of the wall of the tubular main body extending along its circumferential direction,
a first and a second protrusions which are provided on both sides of the notch on the outer surface of the wall with a prescribed spacing from the flange portion,
an electrically conducting connecting member having a base portion, which is loaded in the lamp-loading hole and having a terminal piece, which extends through the notch to a position between the first and the second protrusions.

2. A socket device according to claim 1, wherein a leading end of the terminal piece is placed at a position spaced from the flange portion.

3. A socket device according to claim 2, wherein the terminal piece is in contact with a wire connector formed on a surface of a printed circuit board.

4. A socket device according to claim 3, wherein the tubular main body of the socket device is inserted in a loading hole formed on the printed circuit board and is turned with the printed circuit board sandwiched between the flange portion and the first and the second protrusion, thereby being loaded on the printed circuit board.

5. A socket device according to claim 4, wherein the first protrusion has a stopper portion, which is extended to the flange portion or its vicinity, so as to stop further turning of the socket device on the printed circuit board, when the socket device is loaded on the loading hole of the printed circuit board.

6. A socket device according to claim 5, wherein the second protrusion has an under surface, which faces the flange portion and is so inclined as to make the insertion of the printed circuit board into a space between the under surface of the second protrusion and the flange portion easy, when the socket device is loaded in the loading hole of the printed circuit board.

7. A socket device according to claim 6, wherein a corner portion of the leading end of the terminal piece is bent upward in order to make the insertion of the printed circuit board easy, when the socket device is loaded in the loading hole of the printed circuit board.

8. A socket device according to claim 7, wherein the connecting member supports a sealing portion of the baseless lamp at the base portion loaded in the lamp-loading hole, and contacts with a pair of outer leads of the baseless lamp, which are exposed on both sides of the base portion for electrical connection.

9. A socket device according to claim 8, wherein a pair of pinching pieces is formed on the base portion, the pinching pieces being arranged in parallel and facing each other.

10. A socket device according to claim 9, wherein a convex contacting protrusion is formed at least on one of the pair of pinching pieces, and a coupling convex is formed on the base portion.

11. A socket device according to claim 10, wherein a grasp portion for holding the tubular main body is provided at a portion below the flange portion of the tubular main body.

12. A socket device according to claim 1, a plurality of the notchs are provided on the outer surface of the wall of the tubular main body, wherein the first and the second protrusions are formed on both sides of each of the notch portions, and wherein the electrically conducting connecting member having the base portion, which is loaded in the lamp-loading hole and having the terminal piece, which extends through each of the notch portions to a position between the first and the second protrusions.

13. A socket device according to claim 12, wherein two of the notches are formed on the outer surface of the wall on diametrically opposite positions of the opening of the tubular main body.

14. A socket device according to claim 13, wherein two connecting members are loaded in the lamp-loading hole to support the sealing portion of the baseless lamp at each base portion, and wherein the connecting members contact with the outer lead of the baseless lamp exposed on both sides of the base portion to be electrically connected.

15. A socket device according to claim 14, wherein a grasp portion for holding the tubular main body is provided below the flange portion of the tubular main body.

16. A socket device according to claim 1 or 12, wherein the baseless lamp is an incandescent lamp, a discharge lamp, or a light emitting diode.

17. A lighting device comprising:
a base body,
a printed circuit board provided on the base body, and
a socket device according to the claim 1 or 12 wherein the tubular main body of the socket device is inserted and loaded in the socket loading hole of the printed circuit board with the printed circuit board sandwiched between the flange portion and the first and the second protrusion, thereby being loaded on the printed circuit board.
